(19) United States
(12) Patent Application Publication
(10) Pub. No.: US 2006/0266299 A1
(43) Pub. Date: Nov. 30, 2006

(54) Tethered pet toy and method of use

(76) Inventor: Amanda R. DiAntonio, West Chester, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/140,183

(22) Filed: May 27, 2005

(51) Int. Cl. A01K 29/00

(52) U.S. Cl. 119/708

(57) ABSTRACT

A pet toy system is provided that allows a pet to play with a toy without human supervision. More specifically, the pet toy system allows a pet to play with a toy while impeding displacement of the toy out of a pre-defined area. The pet toy system includes a guide suspended between a pair of supports and a leash that is displaceable along the length of the guide. The pet toy is connected to an end of the leash. Preferably the guide and the leash are configured to maintain the pet toy suspended adjacent the ground.

### FIELD OF THE INVENTION

The present invention relates to a tethered pet toy and a method for using the pet toy. Specifically, the present invention relates to a pet toy connected with an elongated leash, which in turn is connected with a guide wire. In addition, the present invention is operable in connection with an electronic pet containment system.

### BACKGROUND OF THE INVENTION

One of the challenges to owning a pet is maintaining the pet in an enclosed area. Over the years various devices have been utilized to maintain a pet in a particular area. For instance, a fence may be constructed around a particular area or the pet may be attached to a leash that is either retrained in the ground or around a fixed item, such as a pole or a tree. In recent years, the use of electronic pet containment systems have become more frequently used by owners to prevents pets from leaving a particular area, such as the yard around the owner's house. The electronic pet containment systems incorporate a defined perimeter that forms a boundary to the pet. Typically, a wire is buried underground along the perimeter. A special collar is fitted to the pet. If the pet crosses over the wire the collar on the pet provides a shock to the pet. Over time, the pet learns the boundary defined by the wire and resists crossing over the boundary.

The electronic pet containment systems have provided numerous advantages for pets and owners. For instance, a pet can roam freely within a fairly large area without attention from the owner and without the need to construct large fences that can be costly and can close off the area from adjoining property, which may be undesirable.

Although the electronic pet containment systems have been successful in containing pets in a particular area, the systems have not addressed the need of entertaining the pets without the intervention of the owner. In fact, the electronic pet containment systems frequently exacerbate the problem. If a pet is playing with a toy, the electronic pet containment system does not provide a physical barrier to prevent a toy from leaving the area. However, the pet ordinarily will not cross the boundary to retrieve the toy. Instead, the pet will frequently stay on the edge of the boundary and create a disturbance (i.e. a dog will bark incessantly at the toy on the other side of the boundary). The disturbance from the pet creates irritation to others in the area (i.e. owners and neighbors), which may require intervention from the owner to quell the pet.

Accordingly, it would be desirable to provide a device that entertains a pet without need for intervention from the owner or other persons.

### SUMMARY OF THE INVENTION

In light of the foregoing, the present invention provides a method and apparatus to overcome the shortcomings of the prior art. More specifically, the present invention provides a toy that allows for the entertainment of a pet without the need for human intervention.

According to one aspect, a system is provided that includes an elongated leash that is connected with a pet toy and an elongated guide for guiding the leash. The leash and the guide combine to provide an enlarged area in which the pet toy can be displaced, while preventing the toy from escaping from the pet.

According to another aspect, a tethered pet toy is provided that is guided by a trolley cooperable with a guidewire under tension. As the pet toy is displaced, the trolley travels along the guidewire, facilitating displacement of the leash, while at the same time limiting displacement of the leash.

According to another aspect, a tethered pet toy is provided that is connected with a guide extending between a pair of fixed supports, wherein the guide has first and second ends fixedly connected to the supports to prevent displacement of the ends of the guide.

According to yet another aspect, a pet toy is provided, wherein the pet toy is connected with a leash that is cooperable with an elongated guide. The guide extends between a pair of supports and the guide provides for substantially unimpeded displacement along a substantial length of the guide, and preferably along substantially the entire length of the guide.

According to yet a further aspect, a pet toy system is provided that is cooperable with an electronic pet containment system. The pet toy system is configured to cooperate with the pet containment such that the pet toy system allows displacement of a pet toy within the boundaries of the pet containment system while preventing the toy from being displaced across a boundary of the pet containment system.

### BRIEF DESCRIPTION OF THE DRAWINGS

The foregoing summary and the following detailed description of the preferred embodiments of the present invention will be best understood when read in conjunction with the appended drawings, in which:

FIG. 1 is an side view of a pet toy system according to the present invention;

FIG. 2 is an enlarged side cross-sectional view of a portion of the pet toy system illustrated in FIG. 1;

FIG. 3 is a is an exploded perspective view of the portion of the pet toy system illustrated in FIG. 2;

FIG. 4 is a side view of the pet toy system illustrated in FIG. 1 being used by a pet;

FIG. 5 is a plan view of the pet toy system illustrated in FIG. 1 shown in connection with an electronic pet containment system; and

FIG. 6 is a side view of the pet toy system illustrated in FIG. 1 shown in connection with an electronic pet containment system.

### DETAILED DESCRIPTION OF THE INVENTION

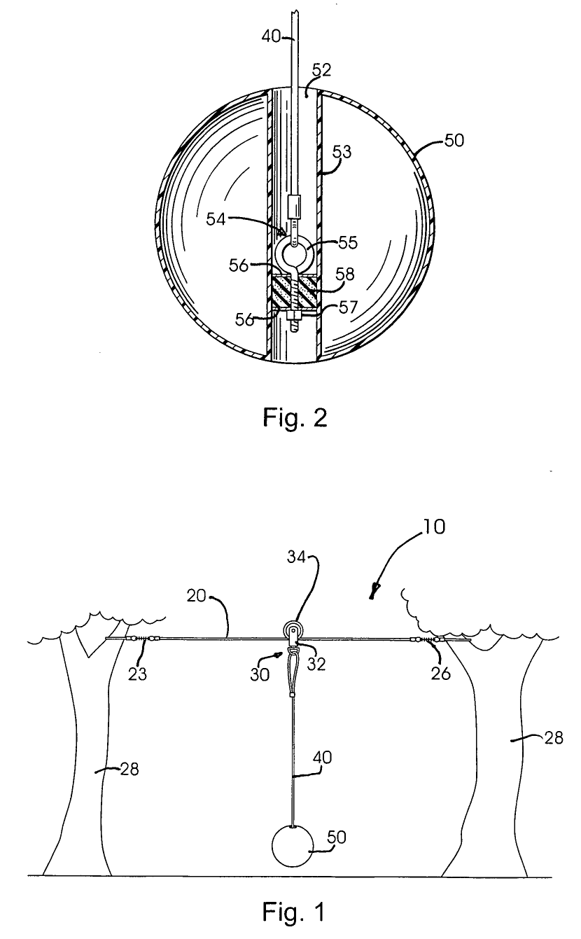

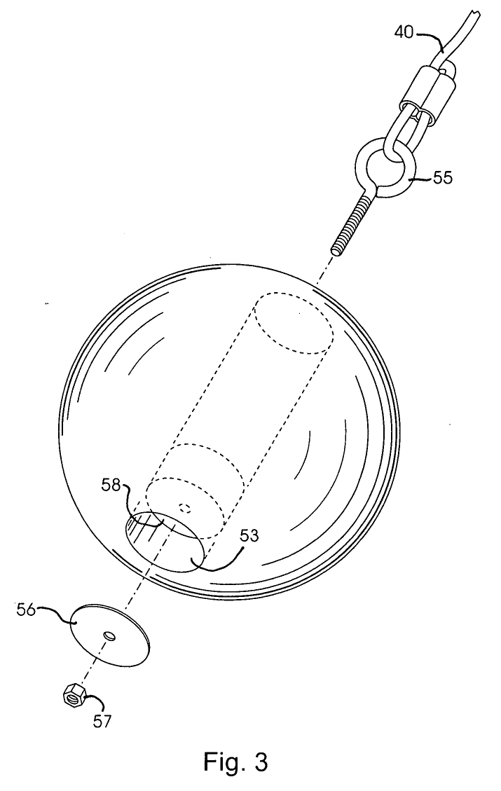

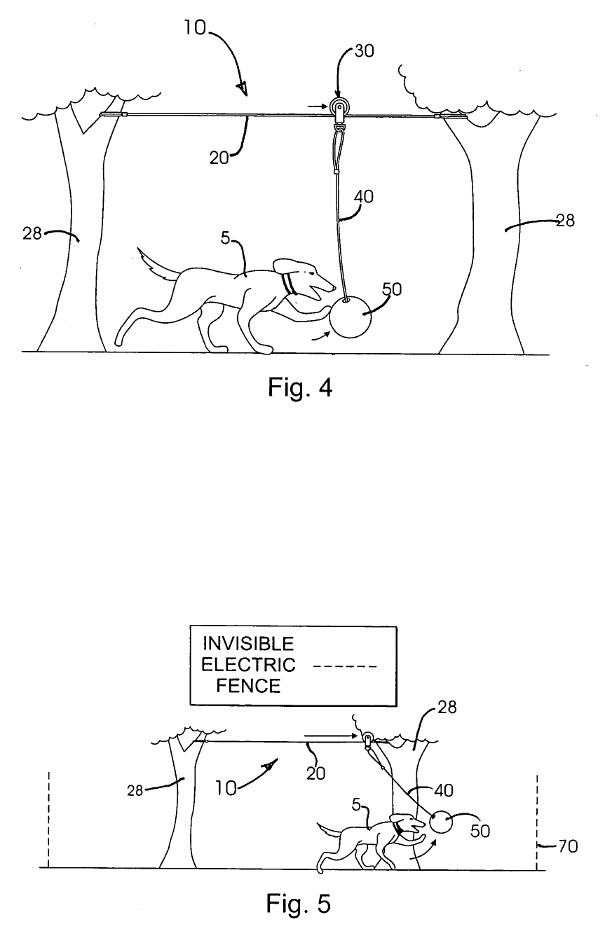

Referring now to FIGS. 1-6, wherein like elements are numbered alike throughout, a tethered pet toy system is designated generally 10. The system 10 includes a pet toy 50 connected to an elongated leash 40. The leash 40 in turn is cooperable with an elongated guide 20 that is supported by a pair of supports 28. The leash 40 and guide 20 combine to allow the pet toy 50 to be displaced within an enlarged area while reducing the risk of the toy being displaced out of reach of a pet 5.

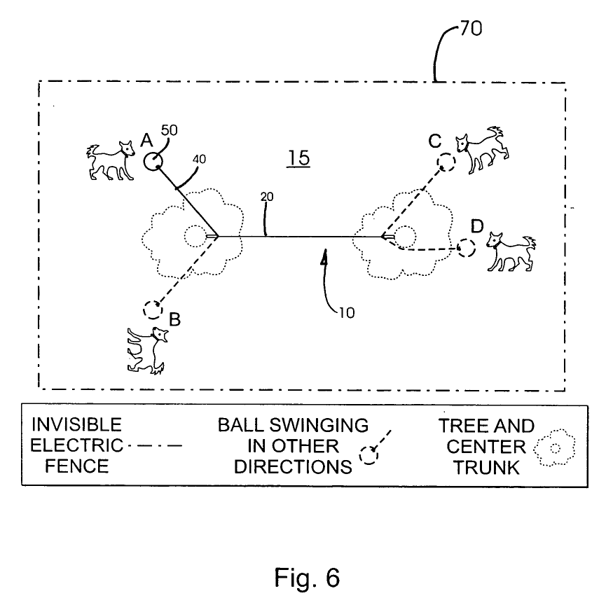

Referring to FIGS. 5 and 6, the pet toy system 10 is operable to allow the pet toy 50 to be readily displaced within a defined area 15 while retaining the pet toy within the defined area. Accordingly, the system is particularly suited for use in connection with an electronic pet containment system 70, which does not provide a physical barrier to impede displacement of the pet toy.

Referring now to FIG. 3, the details of the pet toy system 10 will be defined in greater detail. The pet toy system 10 includes a pet toy 50, which can be configured in one of a variety of shapes and have any of a variety of pet toy characteristics. In the embodiment illustrated, the pet toy 50 is a ball. Specifically, the ball is formed of a durable plastic material, such as a pet toy referred to as a JOLLY BALL manufactured by Horseman's Pride Inc. Although the system 50 is particularly suited for readily displaceable toys, such as a ball, other types of pet toys can be utilized instead, such as a bone, a disk or a ring to name a few examples. Accordingly, the system 10 is not limited to the particular pet toy illustrated.

The system includes a guide 20 for guiding the leash 40 connected to the ball 50. Preferably, the guide is an elongated element of at least approximately 10 feet to allow substantial displacement of the leash 40. The guide may be formed of a variety of elements, however in the present instance the guide is preferably a metal cable. The cable 40 is supported at either end by a pair of supports 28.

It is desirable to retain the system within a pre-defined area 15. Therefore, preferably the supports are fixedly connected to the ground, such as a pole having an end embedded within the ground. Alternatively, in the present embodiment, the supports 28 are a pair of trees.

Each end of the guide 20 is attached to one of the supports 28. Specifically, each end of the guide cable is removably connected to one of the supports 28. In the present embodiment, each end of the guide cable forms a loop that extends around one of the supports. Additionally, it is desirable to retain the guide cable under tension. Therefore, a tensioning element may be provided along the length of the cable. In the present embodiment, a first connector 23 is connected to the first end of the cable 20 adjacent the first end loop, and a second connector 26 is connected to the second end of the cable adjacent the second end loop. Each connecter 23, 26 includes a tensioning element in the form of a biasing element, such as a coil spring, to provide a bias along the axis of the cable.

Referring to FIG. 1, preferably the surface of the cable is substantially smooth to provide a smooth guide surface along substantially the entire length of the cable between the end loops. Specifically, the guide surface continues substantially unobstructed from the first connector 23 to the second connector 26.

The leash 40 attached to the ball 50 is cooperable with the guide cable 20 to control the displacement of the ball. The leash may be connected with the cable in a variety connections that allow the leash 40 to readily displace along the length of the cable, substantially unimpeded. For instance, the top end of the leash may form a loop and the guide cable may extend through the loop on the leash. However, to reduce the resistance between the cable and the leash, in the present instance, a trolley 30 is attached to the top end of the leash to provide a rolling connection between the leash 40 and the cable 20.

The trolley 30 comprises a generally U-shaped yoke 32 and a wheel 34 rotatably connected to the yoke. The legs of the U-shaped yoke 32 extend upwardly, straddling the wheel 34 and the cable 20. Each leg of the yoke has a length that is greater than the diameter of the wheel to provide a clearance opening between the base of the yoke and the perimeter of the wheel. The opening allows the wheel 34 to freely rotate within the yoke and allows the guide cable 20 to extend through the yoke, between the wheel 34 and the base of the yoke without significant interference. In the present embodiment, the wheel 34 also has a groove configured to cooperate with the surface of the guide cable 20.

The trolley 30 provides a smooth rolling interface between the leash 40 and the guide cable 20. The wheel 34 of the trolley 30 rides on top of the cable and follows the guide surface provided by the cable. The weight of the trolley 30, leash 40 and toy 50 pull the wheel downwardly to retain the wheel in engagement with the cable.

The trolley 30 also includes a connector for connecting the leash to the trolley. In the present instance, the trolley includes an eyelet for connecting the leash to the trolley. The top end of the leash forms a loop that extends through the eyelet on the trolley to connect the leash and the trolley.

The leash 40 is an elongated element that extends between the guide cable 20 and the pet toy 50. In the present instance, the leash is formed from a flexible cable, similar to the cable used to form the guide cable 20. However, the leash may be formed of a variety of materials, such as rope or chain. The length of the leash is preferably sufficient to suspend the ball, preferably positioning the pet toy 50 on or slightly above the ground. More specifically, although the length of the leash can vary, preferably the length of the leash is sufficient to position the pet toy within reach of a pet, preferably below 2 feet above the ground. In the present instance, preferably the leash extends between the trolley and the ball a sufficient length to position the pet toy approximately 6-12 inches off of the ground.

Referring now to FIG. 3, the connection between the leash 40 and the toy 50 is illustrated in greater detail. The toy may be attached to the leash using any of a variety of known connections. For instance, the toy 50 may include a hook and the leash may include a cooperating hook that hooks onto the toy. Alternatively, the toy may include an eyelet and the leash may connect to the eyelet similar to the connection between the top of the leash and the trolley. However, preferably the connection between the toy and the leash is positioned within the toy to limit the accessability of the connection. Limiting access to the connection, reduces the ability of the pet to remove the toy from the leash during use.

As shown in FIG. 3, the ball includes a cavity 52 and the leash 40 is connected to the ball within the cavity. The connection is provided by a resiliently deformable friction plug 58 that provides an interference fit with the walls 53 of the cavity. The friction plug 58 is sandwiched between a pair of retention plates or washers 56. One of the plates is positioned on the top end of the plug 58 and the plate is positioned below the bottom end of the plug. The threaded end of an eyebolt 55 extends through the retention plates 56 and the friction plug 58, and threadedly engages a fastener, such as a nut 57 below the bottom retention plate 56. The lower end of the leash 40 forms a loop that extends through the eye of an eyebolt 55. Additionally, the pet toy 50 may include removable top and bottom caps closing the openings to the cavity 52 to limit access to the cavity.

As the eyebolt 55 is threaded into the nut 57 the lower retention plate is displaced toward the upper retention plate, thereby compressing the friction plug between the plates. As the plug is compressed, the periphery of the plug expands radially outwardly into engagement with the cavity wall. As shown in FIG. 3, in the present instance, the walls 53 of the cavity 52 form a generally cylindrical surface. The plug is configured to cooperate with the cylindrical surface of the cavity. More specifically in its relaxed state, preferably the plug has an outer diameter that is similar the diameter of the cylindrical cavity. When the eyebolt is tightened, the plug expands radially outwardly, expanding the diameter of the plug to form an interference fit with the cavity walls. To remove the leash from the ball, the eyebolt or the nut are turned in an opposite direction, to release the compression forces on the plug, allowing the plug to resiliently deform radially inwardly as the plug returns to its relaxed state.

As previously discussed, the pet toy system 10 provides a system that allows for significant displacement of a pet toy, while retaining the pet toy within a defined area. Although the system can be incorporated into a variety of applications, the system has particular application in combination with an electrical pet containment system, such as the systems sold by the company INVISIBLE FENCE INC. An exemplary system is described in U.S. Pat. No. 5,425,330, which is hereby incorporated by reference. However, the pet toy system is not limited to use with an electronic pet containment system, and the containment system disclosed in U.S. Pat. No. 5,425,330 is simply an exemplary system with which the present pet toy system 10 can be used.

Referring now to FIGS. 5 and 6, the pet toy system 10 is illustrated in connection with an electronic pet containment system 70. As shown in FIG. 5, the pet containment system 70 has a perimeter defining a boundary for the containment system. As shown in FIG. 6, the boundary of the electronic containment system 70 extends upwardly from the ground without creating a physical barrier.

Referring again to FIG. 5, the supports 28 are spaced apart from one another and are positioned within the area defined by the perimeter of the containment system 70. In addition, preferably the supports are spaced from the boundary of the pet containment system. Further still, preferably the supports are positioned to retain the pet toy within the perimeter of the pet containment system. As shown in positions A-D illustrated in FIG. 5, displacement of the pet toy is limited by the length of the leash and the length of the guide wire. Preferably the supports are spaced apart from the boundary of the pet containment so that the pet toy remains within the boundary of the per containment system at the lateral and longitudinal limits of displacement of the pet toy.

Configured as described above, the pet toy system 10 operates as follows. The pet toy 50 is attached to the lower end of the leash 40, and the guide wire 20 is threaded through the clearance space in the trolley between the wheel 34 and the yoke 32. A first end of the guide cable 20 is attached to a first support 28, preferably at a height greater than the length of the leash so that the pet toy is suspended above the ground. The second end of the guide cable is then attached to the second support 28, again preferably at a height greater than the length of the leash so that the pet toy is suspended above the ground along the entire length of the guide wire. Although the guide cable 20 may be connected to the supports so that there is slack in the cable, preferably when the second end of the cable is connected to the second support so that the cable is pulled tight to place the cable under tension. Further still, as described above, preferably the connectors 23, 26 comprise tensioning elements that bias the cable toward a tensioned condition.

If the guide cable is positioned too low, the length of the leash can be shortened to position the ball above the ground or as otherwise desired. Alternatively, if the position of the pet toy is higher than desired, the leash may be lengthened to extend the leash. Specifically, in the present embodiment, the loop at the top end of the leash may be created using a removable cable clamp. The clamp can be loosened and repositioned to enlarge or reduce the length of the loop to thereby lengthen or shorten the leash as desired.

After the system 10 is assembled as discussed above, a pet can play with the pet toy alone or with a person. As the pet contacts the toy 50, the pet displaces the toy, both laterally (away from the cable 20) and axially (along the length of the cable). If the toy 50 is suspended above the ground the toy will readily swing around, being displaced from side to side. In addition, the rolling connection between the leash and the guide cable 20 allows the pet to easily displace the toy axially along the length of the cable. If the system 10 is positioned within the boundary of an electronic pet containment system, the pet is free to chase after the pet toy as the toy moves around. More importantly, the guide cable 20 and leash 40 limit the displacement of the toy so that the toy stays within the containment system regardless of how hard the pet hits the toy or how fast the pet chases after the toy. In this way, the system provides a self-contained system for a pet toy that allows significant freedom of movement by the pet, while limiting the need for human supervision.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A pet toy system comprising:
an electronic pet containment system defining a perimeter,
a pair of supports positioned within the perimeter of the pet containment system;
an elongated guide having a length and first and second ends supported by the supports, and providing an elongated guide surface wherein the guide surface is a smooth unobstructed surface extending along the length of the guide;
a leash having a first end cooperable with the guide so that the first end is operable to follow along the guide surface of the guide;
a follower connected to the first end of the leash, wherein the follower is configured to cooperate with the guide; and
a pet toy connected to a second end of the leash remote from the first end of the leash;
wherein the guide is positioned over a surface of the ground and the leash is configured to suspend the pet toy adjacent the surface and the leash and the guide are configured to limit displacement of the pet toy beyond the perimeter of the pet containment system.

2. The pet toy system of claim 1 wherein the pet containment system impedes movement of a pet beyond the perimeter without providing a physical barrier to displacement of the pet toy.

3. The pet toy system of claim 1 wherein the guide surface extends along substantially the entire length of the guide.

4-20. (canceled)

21. A pet toy system, comprising:
an electronic pet containment system defining a perimeter,
a pair of supports positioned within the perimeter of the pet containment system;
an elongated guide having a length and first and second ends supported by the supports;
a leash having a first end cooperable with the guide so that the first end is operable to follow along the guide surface of the guide;
a follower connected to the first end of the leash, wherein the follower is configured to cooperate with the guide; and
a pet toy connected to a second end of the leash remote from the first end of the leash;
wherein the guide and the leash and the guide are configured to limit displacement of the pet toy beyond the perimeter of the pet containment system.

22. The pet toy system of claim 21 wherein the pet containment system impedes movement of a pet beyond the perimeter without providing a physical barrier to displacement of the pet toy.

23. The pet toy system of claim 21 wherein the guide comprises an elongated guide surface that is a smooth unobstructed surface extending along the length of the guide

24. The pet toy system of claim 22 wherein the guide surface extends along substantially the entire length of the guide.

25. The pet toy system of claim 21 wherein the guide is a cable and the follower comprises a wheel in rolling contact with the cable.

26. The pet toy system of claim 21 wherein the guide comprises an elongated flexible element and a tensioner for tensioning the guide toward a tensioned condition.

27. The pet toy system of claim 21 wherein the guide has a first end removably fixed to one of the supports and a second end removably fixed to a second of the supports.

28. The pet toy system of claim 21 wherein the pet toy has an interior and a terminal end of the leash is disposed within the interior of the pet toy.

29. The pet toy system of claim 21 wherein the guide is positioned over a surface of the ground.

30. A pet toy system, comprising:
an electronic pet containment system defining a perimeter,
a support positioned within the perimeter of the pet containment system;
a leash having a first end connected with the support; and
a pet toy connected to a second end of the leash remote from the first end of the leash, wherein the second end of the leash has a terminal end that is disposed within the interior of the pet toy;
wherein the support is positioned from the interior of the perimeter a distance that is greater than the length of the leash to limit displacement of the pet toy beyond the perimeter of the pet containment system.

31. The pet toy system of claim 30 wherein the pet containment system impedes movement of a pet beyond the perimeter without providing a physical barrier to displacement of the pet toy.

32. The pet toy system of claim 30 comprising a guide disposed between the support and the leash, wherein the guide guides the displacement of the leash.

33. The pet toy system of claim 32 comprising a follower connect with the leash, wherein the follower is configured to follow the guide.

34. The pet toy system of claim 33 wherein the guide is a cable and the follower comprises a wheel in rolling contact with the cable.

35. The pet toy system of claim 32 wherein the guide comprises an elongated flexible element and a tensioner for tensioning the guide toward a tensioned condition.

36. The pet toy system of claim 32 wherein the guide is positioned over a surface of the ground.
